(19) United States
(12) Patent Application Publication
(10) Pub. No.: US 2026/0365256 A1
(43) Pub. Date: Nov. 19, 2026

(54) METHOD FOR PRODUCING A STRUCTURAL TRIM PART

(71) Applicant: Weber Fibertech GmbH, 88677 Markdorf (DE)

(72) Inventor: Björn SONNENSTÄDT, Markdorf (DE)

(21) Appl. No.: 19/676,308

(22) Filed: May 13, 2026

(30) Foreign Application Priority Data
May 16, 2025 (DE) 20 2025 102 717.8

(51) Int. Cl. B62D 29/04; B29C 51/08; B29C 51/14; B29K 101/12; B29L 31/30; B60R 13/02; B62D 25/12; B62D 35/00

(52) U.S. Cl. CPC B62D 29/043; B29C 51/082; B29C 51/14; B60R 13/02; B62D 25/12; B62D 35/00; B29K 2101/12; B29L 2031/3058

(57) ABSTRACT

Method for producing a structural trim part for a vehicle, wherein an inner shell is thermoformed in a sandwich construction from a thermoplastic material; an outer shell is thermoformed from a thermoplastic material and simultaneously joined to the inner shell; wherein identical polymers are used for the inner shell and the outer shell.

The invention relates to a method for producing a structural trim part for a vehicle, in particular for a motor vehicle, and to such a structural trim part.

Structural trim parts are components on the vehicle that fulfill both optical and mechanical functions. Such trim parts typically do not serve as load-bearing components, but must nevertheless be suitable for absorbing mechanical loads.

Roof spoilers, wind deflectors, hoods or similar flat components in the exterior area of vehicles are examples of structural trim parts. Their purpose is to conceal underlying structures, cover cavities and/or positively influence the aerodynamic properties of the vehicle. They are therefore subject to fluid-mechanical forces and, as a result, must neither fail nor deform to a large extent. For this reason, the construction of these components requires, firstly, a certain structural stability. Secondly, exterior components must meet high requirements regarding their visual appearance. Their appearance must not be unduly affected by weather conditions.

A common production method is the so-called LFI process (LFI: long fiber injection), in which a deep-drawn plastic shell is sprayed in a second process step with a resin/glass-fiber mixture and lined. A disadvantage of this method is, for example, the lack of sustainability of the thermoset-based plastic. Because of its chemical cross-linking during production, it is not reversible. Therefore, the material cannot be recycled into any further process. Consequently, it is hazardous waste that, at best, can be used as filler in road construction. Secondly, due to the solid construction, there is little potential for lightweight construction.

DE 10 2008 039 406 A1 describes a method for producing hollow bodies from two or more fused half-shells of different sizes made of thermoplastic materials. The method involves fusing a deep-drawn film web with one or more smaller deep-drawn elements.

From DE 10 2018 131 722 A1, a mold tool for joining trim parts with flat decorative materials and a corresponding method are known. The mold tool has a first and a second mold half, which can be positioned in an open position and a closed position relative to each other, and between which a joining gap is provided. Furthermore, a holding frame is provided, which is detachably fixed adjacent to the joining gap on one of the mold halves.

DE 10 2008 035 918 A1 describes a method for producing a composite component made of plastic, in which a decorative composite is produced, a structural composite is produced, and a bonding layer is introduced between the decorative composite and the structural composite. An additional layer, the bonding layer, is therefore required.

Against this background, a method for producing a structural trim part having the features of claim 1, and a structural trim part according to claim 5, which is manufactured in particular using the described method, are presented. Embodiments are shown in the dependent claims and in the description.

The presented method serves for producing a structural trim part for a vehicle, wherein an inner shell is thermoformed from a thermoplastic material in a sandwich construction, an outer shell is thermoformed from a thermoplastic material and simultaneously joined, i.e., connected, with the inner shell, wherein identical polymers are used for the inner shell and the outer shell, have different morphologies and thus different properties due to their design.

Identical polymers are polymers of the same type, i.e., plastics that are made up of the monomer and therefore have the same basic chemical structure. Polymers of the same type therefore comprise the same building blocks, but can have different structures. Typically, both plastics consist exclusively of polymers of the same type.

In one embodiment, the same polymers are used for the inner shell and the outer shell. Identical polymers are completely identical in monomer composition, structure and chain length and therefore have the same properties.

Furthermore, the outer shell can be deep-drawn in a mold tool. During deep drawing, the inner shell is pressed into the outer shell and joined with it.

Furthermore, the inner shell can be embossed, at least in sections. In a special embodiment, the inner shell is embossed on its end face.

During production, additional functional elements can be integrated into the inner shell.

The presented structural trim part is designed for use in or on a vehicle, in particular a motor vehicle, and has an inner shell and an outer shell. The inner shell is made of a thermoplastic material in a sandwich construction, i.e., the inner shell has a sandwich structure.

The outer shell is also made of a thermoplastic material and is arranged in such a way relative to the inner shell that the inner surface of the outer shell rests at least partially against the outer surface of the inner shell. The inner shell and the outer shell are made of identical polymers, possibly even identical polymers, which have different morphologies and therefore different properties in their design.

The proposed structural trim part should be able to support itself, should be relatively rigid, and should not break under load.

In the sandwich construction, materials with different properties are combined in layers to form a component. The sandwich structure of the inner shell is typically characterized by two opposing outer layers, between which a core layer is provided. The outer layers regularly exhibit high mechanical properties, meaning they can withstand high mechanical loads without being compromised.

The core layer keeps the two outer layers space apart. Typically, the core layer is particularly light, i.e., it has a low density, especially a lower density than the outer layers. While the same material can generally be used for the core layer as for the outer layers, it will then have a different morphology.

Thermoplastic polymers are characterized by the fact that they become soft and malleable when heated and harden again when cooled, without their chemical structure being altered.

In its design, the structural trim part is, for example, designed as a flat component and is intended for use on the exterior of the vehicle. This particularly flat component is intended to convey a visual impression and must also be suitable for absorbing mechanical loads or stresses. One possible application is in roof spoilers, wind deflectors and hoods. However, other interior applications can also be contemplated.

In a further embodiment, the structural trim part is designed, for example, as a flat component and is intended for use in the interior of the vehicle. This particularly large, flat component should exhibit a certain degree of stability in interior applications and meet visual requirements. One possible application is, for example, its use in the form of doors for storage compartments. However, other interior applications can also be contemplated.

It should be noted that the trim part and the associated production method are suitable for many applications. This includes, for example, vehicle interiors, boat hulls and building facades. This can be summarized as: wherever light weight and stiffness are functional requirements that are made possible by sandwich materials. Aesthetic requirements are met through outer plastics.

In one embodiment, the trim part is designed as a component selected from a group consisting of: roof spoiler, wind deflector, hood.

The outer shell can be designed as a deep-drawn component.

The inner shell may be embossed, at least in sections, e.g., on the end face. This is merely one option.

Furthermore, additional functional elements can be integrated into the inner shell.

In a further embodiment, the inner shell has a recess in at least one area.

The proposed structural trim part uses exclusively thermoplastic-based plastics, which are generally recyclable.

The implementation of lightweight construction and structural stability is to be made possible by the use of thermoplastic-based sandwich materials, which are characterized by having outer and/or cover layers that are kept spaced apart by means of a structured core layer, thus ensuring high overall structural stiffness at a relatively low overall density. A second component, made of the same type of polymer, coats the structural sandwich material, providing a weather-resistant and visually appealing outer skin.

The thermoplastic outer shell, which is deep-drawn in its design, meets the requirements for appearance and weather resistance. However, this alone cannot provide the necessary stiffness. However, the outer shell presented allows for complex geometries, degrees of deformation, or drawing depths that cannot be achieved with the sandwich material of the inner shell.

The sandwich structure of the inner shell, located behind the outer shell, provides the necessary stiffness, which is often required due to aerodynamic loads. Furthermore, support or retaining elements can be attached to it, through which forces are introduced into or dissipated from the component. This structural element can either fully support the outer surface or only partially. This depends, firstly, on the complexity of the outer shell; complex areas may be left out of the sandwich material to simplify its molding. Secondly, it depends on the mechanical requirements. Areas subject to mechanical stress are reinforced with sandwich material, while areas not subject to stress are deliberately left out. Furthermore, the sandwich material can be adapted in its morphology, especially with regard to material and wall thickness distribution, to meet the corresponding structural requirements.

The construction of the structural trim part typically consists of an outer layer that ensures both a flawless appearance and a specific color scheme. This outer layer is reinforced with a structural layer to ensure sufficient stiffness and strength of the composite component. By using materials that all consist of the same thermoplastic polymer, which is called mono-material construction, and by eliminating the need for a coat of paint because the outer layer material is colored directly, the composite is completely recyclable. The different properties within the composite are differentiated by the morphology of the respective layers.

The use of identical polymers (the same polymer) allows for an efficient production method that eliminates the need for additional welding and painting processes. The production process comprises only two steps:
a. molding the structural layer that forms the inner shell,
b. molding the outer layer and synchronously/simultaneously joining and/or connecting it to the structural layer.

It is understood that the features mentioned above and those to be explained below can be used not only in the combination indicated in each case, but also in other combinations or on their own, without going beyond the scope of the present invention.

Further advantages and embodiments of the invention are shown in the description and the accompanying drawing.

### BRIEF DESCRIPTION OF THE DRAWING

FIG. 1 shows two illustrations of an embodiment of the presented structural trim part.

FIG. 2 shows a flowchart illustrating a possible embodiment of the method for producing the presented structural trim part.

### EMBODIMENTS OF THE INVENTION

The invention is shown schematically by means of embodiments in the drawing and is described in detail below with reference to the drawing.

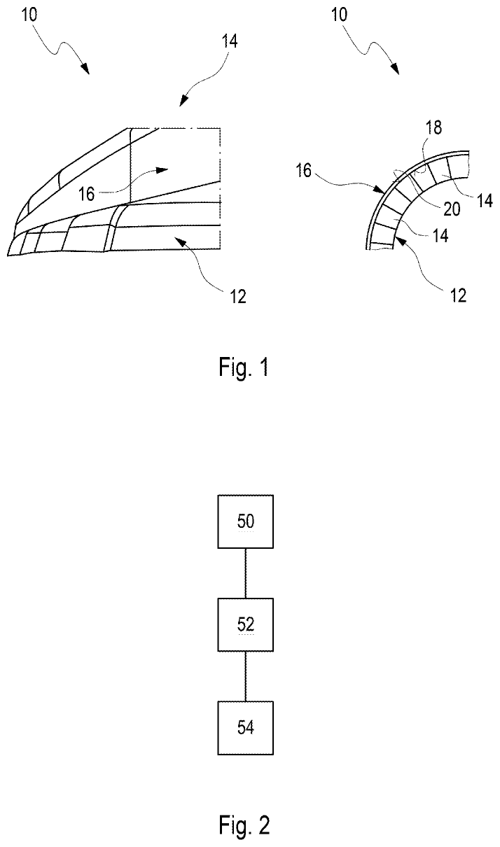

FIG. 1 shows in two illustrations an embodiment of the presented structural trim part, which is generally designated by the reference numeral 10. The illustration on the left shows the structural trim part 10 in a perspective view. On the right side, the structural trim part 10 is shown in a schematic sectional view.

FIG. 1 shows an inner shell 12 made of a sandwich of thermoplastic material. This inner shell 12 may, particularly in complex areas, have recesses 14. Furthermore, an outer shell 16 is shown, which is designed as a deep-drawn outer shell 16.

The inner shell 12 and the outer shell 16 are arranged in such a way that an inner surface 18 of the outer shell 16 is almost entirely in contact with an outer surface 20 of the inner shell 12.

The complete structure of the component shown in FIG. 1 consists of thermoplastic-based materials. This way, the possibility of recycling can also be preserved.

This results in a double-shell mono-material composite construction, in which a structural inner shell 12 and a particularly visually appealing outer shell 16, which also protects against weather influences, are provided.

As the illustration shows, the structural, thermoplastic-based sandwich material is located on the inside of the component in the non-visible area; it is formed and possibly embossed in a thermoforming process. In this step, the inner shell 12 receives its basic shape, which substantially corresponds to the component surface. However, it may also be omitted in certain areas.

The sandwich material can be embossed on the end face for lateral sealing or consolidation. This can also be done in areas that will later be fitted with screws. The solid material structure ensures a secure screw connection in this area. For further functionalization, additional functional elements can be attached to the inner shell 12 using welding processes.

The outer shell 16 of the structural trim part 10 is regularly based on the same polymer as the inner shell 12 and is usually manufactured using the deep drawing process. The outer surface 20 of the inner shell 12 and the inner surface 18 of the outer shell 16 are almost identical in size and shape. The outer shell 16 can be manufactured separately and subsequently connected to the inner shell 12. It can also be pulled directly over the inner shell 12, if necessary.

FIG. 2 shows a flowchart illustrating a possible sequence of the method for producing a structural trim part of the type described herein.

In a first step 50, the inner shell is manufactured and shaped using a sandwich structure and a thermoplastic material. This inner shell substantially already has the shape of the structural trim part to be manufactured. In a further step 52, the outer shell is then applied to the inner shell in a deep drawing process, wherein after this step 52 the outer shell largely covers the outer surface of the inner shell. Finally, in a step 54, functional elements are attached to the inner shell. The functional elements can also be attached before the outer shell is deep-drawn.

In this embodiment, the structural inner shell is thermoformed in a first production step; this means that the sandwich-shaped sheet material of the inner shell is first heated in order to then be pressed into shape using a two-part tool mold.

In the second production step, the outer shell is thermoformed and joined simultaneously or concurrently or synchronously with the inner shell. The monolithic sheet material is thus heated in order to then deep-draw it in a tool mold. During deep drawing, the inner shell is pressed and joined into the still warm and malleable material of the outer shell. This substantially represents an integrated welding process. An additional layer, as is known in the prior art, is not necessary.

The thermal energy of the outer shell is sufficient to heat the joining partner, the top layer of the inner shell, and fuse them together.

1-13. (canceled)

14. Method for producing a structural trim part for a vehicle, comprising the steps of:
thermoforming an inner shell in a sandwich construction from a thermoplastic material;
thermoforming an outer shell from a thermoplastic material and simultaneously joining to the inner shell;
wherein identical polymers are used for the inner shell and the outer shell.

15. Method according to claim 14, wherein the same polymers are used for the inner shell and the outer shell.

16. Method according to claim 14, wherein the outer shell is deep-drawn in a tool mold and, during the deep-drawing process, the inner shell is pressed into the outer shell and joined to it.

17. Method according to claim 14, wherein the inner shell is embossed at least in sections.

18. Structural trim part for a vehicle, comprising:
an inner shell and an outer shell;
wherein the inner shell is made of a thermoplastic material in a sandwich construction;
the outer shell is made of a thermoplastic material and is arranged in relation to the inner shell such that an inner surface of the outer shell lies at least partially against an outer surface of the inner shell; and
wherein identical polymers are used for the inner shell and the outer shell.

19. Structural trim part according to claim 18, wherein the structural trim part is a flat component disposed on an exterior part of the vehicle.

20. Structural trim part according to claim 19, wherein the structural trim part is a component selected from a group consisting of: roof spoiler, wind deflector, hood.

21. Structural trim part according to claim 18, wherein the structural trim part is disposed in an interior part of the vehicle.

22. Structural trim part according to claim 18, wherein the outer shell is designed as a deep-drawn component.

23. Structural trim part according to claim 18, wherein the inner shell is embossed at least in sections.

24. Structural trim part according to claim 23, wherein the inner shell is embossed on its end face.

25. Structural trim part according to claim 18, wherein further functional elements are integrated on the inner shell.

26. Structural trim part according to claim 18, wherein the inner shell has a recess in at least one region.
